(19) United States
(12) Patent Application Publication
(10) Pub. No.: US 2026/0245375 A1
(43) Pub. Date: Aug. 20, 2026

(54) OBSTACLE PROMPTING METHOD, COMPUTING DEVICE, MEDIUM, AND MOBILE DEVICE

(71) Applicant: Arashi Vision Inc., Shenzhen (CN)

(72) Inventors: Chunhong DENG, Shenzhen (CN); Yongjie Huang, Shenzhen (CN); Rui Xu, Shenzhen (CN)

(73) Assignee: Arashi Vision Inc., Shenzhen (CN)

(21) Appl. No.: 19/642,739

(22) Filed: Apr. 9, 2026

Related U.S. Application Data
(63) Continuation of application No. PCT/CN2024/101803, filed on Jun. 27, 2024.

(51) Int. Cl. G06V 20/58; G06T 7/50; G06T 7/62; G06V 10/74; G06V 20/17

(52) U.S. Cl. CPC G06V 20/58; G06T 7/50; G06T 7/62; G06V 10/761; G06V 20/17; G06T 2207/10028; G06V 2201/07

(57) ABSTRACT

A computing device may include a memory, a processor, and a display. The memory stores a computing program, and when the computing program is executed by the processor, the processor is configured to perform receiving a real-time image captured by a mobile structure; displaying the real-time image at an interactive interface of the display; and in response to presence of a target obstacle in a current movement area of the mobile structure, displaying obstacle prompting information in a prompting area corresponding to the current movement area in the real-time image.

### CROSS-REFERENCE TO RELATED APPLICATION

The present application is a continuation of International Application No. PCT/CN2024/101803, filed Jun. 27, 2024, the contents of which are being incorporated herein by reference in its entirety.

### TECHNICAL FIELD

This disclosure relates to, but is not limited to, an obstacle prompting method, a computing device, a medium, and a mobile device.

### BACKGROUND

In recent years, with rapid development of obstacle detection technology and continuous iteration of electronic devices, mobile devices such as UAVs having obstacle prompting functions have been widely used. They can provide obstacle promptings during use, allowing users to adjust direction of travel of the device in real time to avoid obstacles.

### SUMMARY

In a first aspect, one embodiment of the present application provides a computing device. The computing device may include a memory, a processor, and a display. The memory stores a computing program, and when the computing program is executed by the processor, the processor is configured to perform receiving a real-time image captured by a mobile device; displaying the real-time image at an interactive interface of a display device; and in response to presence of a target obstacle in a current movement area of the mobile device, displaying obstacle prompting information in a prompting area corresponding to the current movement area in the real-time image.

In a second aspect, one embodiment of the present application provides an obstacle prompting method, the obstacle prompting method comprising: receiving a real-time image captured by a mobile device; displaying the real-time image at an interactive interface of a display device; and in response to presence of a target obstacle in a current movement area of the mobile device, displaying obstacle prompting information in a prompting area corresponding to the current movement area in the real-time image.

In a third aspect, one embodiment of the present application provides an obstacle prompting method, the obstacle prompting method comprising: sending the captured real-time image to a display device so that the display device performs the obstacle prompting method as described in the second aspect.

In a fourth aspect, one embodiment of the present application provides a non-transitory computing-readable storage medium having a computing program stored thereon, which, when executed by a processor, implements the steps of the method described in the second aspect.

In a fifth aspect, one embodiment of the present disclosure provides a mobile device, the mobile device is configured to perform the obstacle prompting method as described in the second aspect.

In a sixth aspect, one embodiment of the present disclosure provides a display device, the display device is configured to perform the obstacle prompting method as described in the second aspect.

In an obstacle prompting method, computing device, and medium provided according to some embodiments of this disclosure, the current movement area of the mobile device is used as a determination area for whether a target obstacle exists, and obstacle prompting information is displayed in the corresponding prompting area. This makes the detection range and the prompting range of the obstacle compatible with actual movement range of the mobile device, thereby improving accuracy of obstacle prompting, reducing signal interference, and enhancing user experience.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a schematic diagram of an obstacle detection range and obstacles in related art;

FIG. 2 is an application scenario diagram of an obstacle prompting method according to an exemplary embodiment;

FIG. 3 is a flowchart illustrating an obstacle prompting method according to an exemplary embodiment;

FIG. 4 is a schematic diagram illustrating a real-time image according to an exemplary embodiment;

FIG. 5 is a schematic diagram of a current movement area according to an exemplary embodiment;

FIG. 6 is a top view of a current movement area and obstacles according to an exemplary embodiment;

FIG. 7 is a schematic diagram illustrating a mobile device and a current movement area according to an exemplary embodiment;

FIG. 8 is a flowchart illustrating a display of obstacle prompting information in a prompting area according to an exemplary embodiment;

FIG. 9 shows a schematic diagram of a prompt color block in a real-time image according to an exemplary embodiment;

FIG. 10 shows a schematic diagram of a prompt line in a real-time image according to an exemplary embodiment;

FIG. 11 is a flowchart illustrating determination of a target obstacle within a current movement area according to an exemplary embodiment;

FIG. 12 is a flowchart illustrating determination of a target obstacle in a current movement area based on a detection image according to an exemplary embodiment;

FIG. 13 is a flowchart illustrating determination of first obstacle information based on a first depth image according to an exemplary embodiment;

FIG. 14 is a flowchart illustrating determination of a target obstacle within a current movement area based on a detection image according to another exemplary embodiment;

FIG. 15 is a flowchart illustrating determination of second obstacle information based on a second depth image according to an exemplary embodiment;

FIG. 16 is a flowchart illustrating display of obstacle prompting information in a prompting area according to another exemplary embodiment;

FIG. 17 is a flowchart illustrating determination of a target obstacle in a current movement area based on a detection image according to another exemplary embodiment;

FIG. 18 is a flowchart illustrating determination of a target obstacle within a current movement area based on a detection image according to another exemplary embodiment;

FIG. 19 is a flowchart illustrating an obstacle prompting method according to another exemplary embodiment;

FIG. 20 is a flowchart illustrating an obstacle prompting method according to another exemplary embodiment;

FIG. 21 is a block diagram of a computing device according to an exemplary embodiment.

### FIGURE SYMBOLS

1. Mobile device; 2. Display device; 3. Remote control device; 10. Current movement area; 20. Prompting area; 30. Prompting color block; 40. Prompting line; 100. Computing device; 101. Computing unit; 102. ROM; 103. RAM; 104. Bus; 105. Input/output interface; 106. Input unit; 107. Output unit; 108. Storage unit; 109. Communication unit.

### DETAILED DESCRIPTION

To make the purpose, technical solutions and advantages of embodiments of the present application clearer, the specific technical solutions of the present application will be further described in detail below in conjunction with the drawings in the embodiments of the present application. The following embodiments are used to illustrate the present application but are not intended to limit the scope of the present application.

The technical solutions of the disclosed embodiments will be clearly and completely described below with reference to the accompanying drawings. Obviously, the embodiments described are only some, not all, of the embodiments of this disclosure. Based on the embodiments of this disclosure, all other embodiments obtained by those skilled in the art without creative effort are within the scope of protection of this disclosure. It should be noted that, unless otherwise specified, the embodiments and features in the embodiments of this disclosure can be arbitrarily recombined with each other.

In recent years, with rapid development of obstacle detection technology and continuous iteration of mobile devices such as UAVs and remote-controlled cars, mobile devices with obstacle prompting functions have been widely used in many fields. Such mobile device can provide obstacle promptings through voice, images, and text during use of the mobile device, so that a user can adjust moving direction of the mobile device in real time to avoid obstacles.

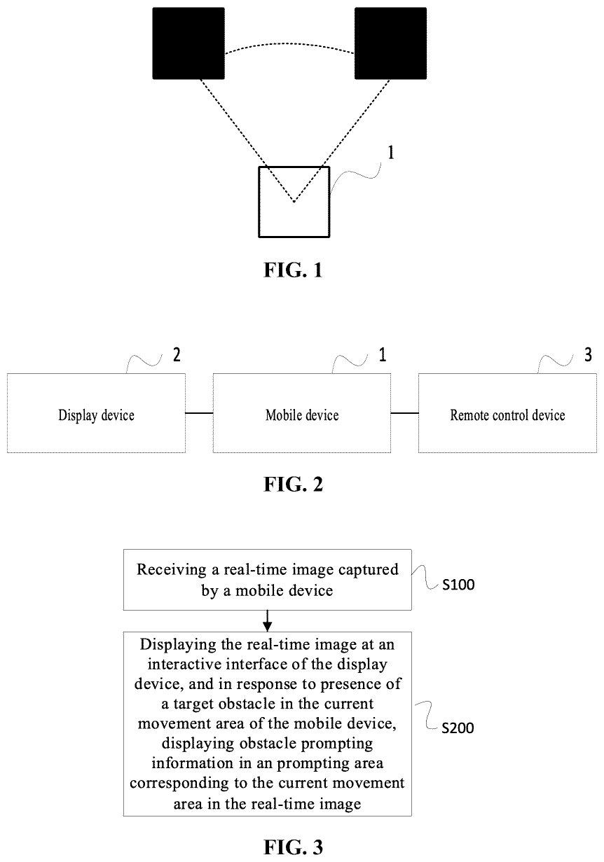

In related technologies, as shown in FIG. 1, projection of an obstacle detection range onto a plane looking down is usually a fan-shaped area centered on the mobile device. When an obstacle is detected within the detection range, a prompting signal will be issued.

However, when using obstacle prompting methods in related technologies to provide obstacle promptings, the detection range of the obstacle is inconsistent with actual movement range of the mobile device. Even if the mobile device can successfully pass through the obstacles while maintaining its direction of movement, it will still issue an obstacle prompting signal. In many usage scenarios such as UAV obstacle avoidance flight competitions, this will interfere with users, resulting in problems such as low accuracy of obstacle promptings and strong interference, which will affect user experience.

This disclosure provides an exemplary embodiment of an obstacle prompting method, a computing device, a medium, and a mobile device. By receiving a real-time image captured by the mobile device, the real-time image can be displayed on an interactive interface of a display device. When a target obstacle exists within the current movement area of the mobile device, obstacle prompting information is displayed in a prompting area corresponding to the current movement area in the real-time image, thus achieving automatic obstacle prompting. By using the current movement area of the mobile device as a determination area for the presence of a target obstacle and displaying obstacle prompting information in the corresponding prompting area, the detection range and the prompting range of the obstacle are adapted to actual movement range of the mobile device, thereby improving accuracy of obstacle prompting, reducing signal interference, and enhancing the user experience.

An obstacle prompting method provided in one embodiment of this application can be applied to an application scenario shown in FIG. 2. This application scenario includes a mobile device or structure 1, a display device or display 2, and a remote control device or controller 3. The mobile device 1 is communicatively connected to both the display device 2 and the remote control device 3. The display device 2 can receive a real-time image captured by the mobile device 1 and display the real-time image on its interactive interface. When a target obstacle exists in a current movement area of the mobile device 1, obstacle prompting information is displayed in the prompting area corresponding to the current movement area in the real-time image. A user can adjust moving direction of the mobile device 1 to avoid the obstacle using the remote control device 3 based on the obstacle prompting information. The mobile device 1 can be, for example, an unmanned aerial vehicle (UAV) or a remote-controlled car, and the display device 2 can be, for example, a wearable device such as glasses or a terminal device such as a mobile phone. The type of display device 2 is not limited to these. Display devices 2 that have problems such as low obstacle prompting accuracy or strong interference can all adopt the obstacle prompting method provided in this embodiment.

In one exemplary embodiment, an obstacle prompting method is provided for a display device 2. The display device 2 may be, for example, a wearable device such as glasses capable of displaying an image or a terminal device such as a mobile phone. As shown in FIG. 3, the obstacle prompting method in one embodiment of the present disclosure includes the following steps:
Step S100: receiving a real-time image captured by a mobile device.

In step S100, the display device 2 receives a real-time image captured by the mobile device 1. The real-time image captured by the mobile device 1 can reflect moving perspective of the mobile device 1. When the mobile device 1 moves, the real-time image captured by the mobile device 1 changes synchronously.

For example, the mobile device 1 is an UAV, and the display device 2 is glasses. The UAV and glasses are connected in communication. The UAV can capture a real-time image through the camera installed on it and send the image data corresponding to the real-time image to the glasses so that the glasses can receive the real-time image captured by the UAV.

Step S200: displaying the real-time image at an interactive interface of the display device, and in response to presence of a target obstacle in the current movement area of the mobile device, displaying obstacle prompting information in an prompting area corresponding to the current movement area in the real-time image.

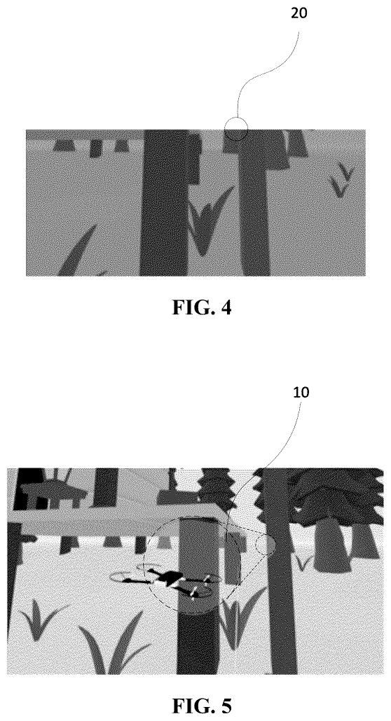

In step S200, the received real-time image as shown in FIG. 4 is first displayed on the interactive interface of the display device 2, so that the user can observe the real-time image captured by the mobile device 1 through the interactive interface of the display device 2 and experience the moving perspective of the mobile device 1.

As shown in FIG. 5, the current movement area 10 of the mobile device 1 is a spatial area that the mobile device 1 may pass through while maintaining its current moving direction. A borderline of the current movement area 10 corresponds to a size of the mobile device 1, and an extension direction of the current movement area 10 is consistent with a current moving direction of the mobile device 1. A target obstacle refers to an obstacle that will interfere with the current moving direction when moving in the current moving direction. A target obstacle can be all obstacles existing in a certain spatial area, or it can be a portion of the obstacles existing in a certain spatial area that meet certain conditions. For example, a target obstacle can be an obstacle closest to the mobile device 1.

When a target obstacle exists within the current movement area 10 of the mobile device 1, obstacle prompting information is displayed in a prompting area 20 of the real-time image displayed on the interactive interface of the display device 2. The prompting area 20 in the real-time image corresponds to the current movement area 10 of the mobile device 1 in actual physical space. If the borderline of the current movement area 10 is circular, the prompting area 20 is also circular. The obstacle prompting information displayed in the prompting area 20 can indicate to a user that a target obstacle exists within the current movement area 10 of the mobile device 1. The obstacle prompting information can be, for example, text, color blocks, or lines.

It is understandable that using the current movement area 10 of the mobile device 1 as a determination area for existence of a target obstacle can make the detection range of the obstacle match actual movement range of the mobile device 1, avoiding the problem in related technologies where the mobile device 1 can successfully pass through obstacles while maintaining the same direction of movement, but still emits an obstacle prompting signal, thus reducing unnecessary signal interference.

In this embodiment, by receiving a real-time image captured by the mobile device 1, the real-time image can be displayed on the interactive interface of the display device 2. When a target obstacle exists within the current movement area 10 of the mobile device 1, obstacle prompting information is displayed in the prompting area 20 corresponding to the current movement area 10 in the real-time image, thus achieving automatic obstacle prompting. By using the current movement area 10 of the mobile device 1 as the determination area for the existence of a target obstacle and displaying obstacle prompting information in the corresponding prompting area 20, the detection range and the prompting range of the obstacle are adapted to actual movement range of the mobile device 1, thereby improving accuracy of obstacle prompting, reducing signal interference, and enhancing user experience.

In some embodiments, the mobile device 1 is an UAV, the current movement area 10 is in a cylindrical shape, an axis of the current movement area 10 is parallel to a current moving direction of the UAV, and a bottom surface of the cylindrical shape is configured such that the smallest circumcircle of the UAV's projection on a preset plane is inside the bottom surface area, and the preset plane is perpendicular to a direction from a tail to a head of the UAV.

The mobile device 1 is an UAV. The current movement area 10 is cylindrical having a three-dimensional shape with two parallel bases. Side borderlines of the cylinder are side borderlines of the current movement area 10, which extends along a height direction of the cylinder. A height of the cylinder is a preset obstacle detection distance. The two bases of the cylinder can be equal or unequal, depending on the user's actual detection needs. For example, in a conventional scenario, the two bases of the cylinder can be set to be equal, ensuring that the planar projection of the current movement area 10 (the obstacle detection area) remains constant from near to far from the mobile device 1. In unconventional scenarios, the two bases of the cylinder can be set to be unequal; for example, the base closer to the mobile device 1 can be set larger, and the base farther away can be set smaller, causing the planar projection of the current movement area 10 (the obstacle detection area) to gradually decrease from near to far from the mobile device 1. Understandably, as the planar projection of the current movement area 10 gradually shrinks from near to far in the space of the mobile device 1, it can maintain a large planar detection range when the mobile device 1 is close to the obstacle, and appropriately shrink the planar detection range when the mobile device 1 is far from the obstacle. Under premise of ensuring that all obstacles that may collide with the mobile device 1 are detected, the number of detection targets can be reduced, thereby improving the response speed.

In one embodiment, an axis of the UAV's current movement area 10, i.e., its extension direction, is parallel to the UAV's current moving direction, i.e., its current flight direction. The base of the cylinder is configured to include the smallest circumcircle of the UAV's projection onto a preset plane. This smallest circumcircle may be inscribed within the edge of the base or may not intersect with it. The preset plane is perpendicular to the direction from the UAV's tail to its nose, i.e., its current flight direction. For example, the shape of the cylinder's base may include, for instance, a circle, rectangle, triangle, and other polygonal or irregular shapes. The shape and size of the cylinder's base ensure that the smallest circumcircle of the UAV's projection onto the preset plane lies within the area defined by the base.

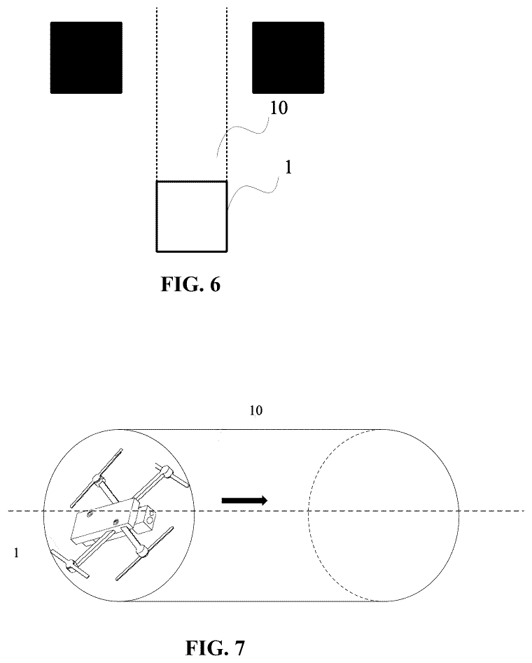

Understandably, the base of the cylinder is configured to encompass the smallest circumcircle of the UAV's projection onto the preset plane. This ensures the UAV remains within the current movement area 10 while maintaining its current moving direction, allowing all potential obstacles to be detected when the current movement area 10 is used as the target obstacle detection area. If the base of the cylinder is circumcircle of the smallest circumcircle of the UAV's projection onto the preset plane, then, unlike related technologies that issue promptings within the obstacle detection range shown in FIG. 1, no obstacle prompting information will be displayed if the obstacle does not exist within the obstacle detection range shown in FIG. 6, in the same scenario.

In this embodiment, the current movement area 10 of the UAV is cylindrical, and the axis of the current movement area 10 is parallel to the current moving direction of the UAV. The bottom surface of the cylinder is configured to include the smallest circumcircle of the UAV's projection on a preset plane. When the UAV maintains its current moving direction, it can always stay within the current movement area 10. This allows all obstacles that may collide with the UAV to be detected when the current movement area 10 is used as the target obstacle detection area. It also avoids invalid prompts while obstacles can be crossed, making the obstacle detection range match the actual travel range of the mobile device 1. This improves accuracy of obstacle prompts, reduces signal interference, and enhances user experience.

In some embodiments, the current movement area 10 is cylindrical, and a diameter of the current movement area 10 is equal to or greater than a diameter of the smallest circumcircle of the projection of the UAV onto a preset plane.

As shown in FIGS. 5, 6, and 7, the current movement area 10 of the UAV is cylindrical. A periphery of the bottom surface of the cylinder is a periphery of the current movement area 10. The current movement area 10 extends along the height direction of the cylinder, and the height of the cylinder is the preset obstacle detection distance. At any given time, the axis of the current movement area 10, i.e., the direction of extension, is parallel to the current moving direction of the UAV, i.e., the current flight direction. The diameter of the current movement area 10 is equal to or greater than the diameter of the smallest circumcircle of the UAV's projection onto the preset plane, i.e., a maximum size of the UAV in any direction within the preset plane. The preset plane is perpendicular to the direction from the tail to the nose of the UAV, i.e., the current flight direction.

It is understandable that if the diameter of the current movement area 10 is equal to or greater than the diameter of the smallest circumcircle of the UAV's projection onto the preset plane, the UAV can always remain within the current movement area 10 while maintaining its current moving direction. This ensures that all obstacles that may collide with the UAV can be detected when the current movement area 10 is used as the target obstacle detection area. If the current movement area 10 is equal to or slightly greater than the diameter of the smallest circumcircle of the UAV's projection onto the preset plane, then, in the same scenario, unlike related technologies that issue a prompting within the obstacle detection range shown in FIG. 1, no obstacle prompting information will be displayed if the obstacle does not exist within the obstacle detection range shown in FIG. 6.

Since the UAV may rotate around the direction of its tail to its head during flight, setting the current movement area 10 to a cylindrical shape ensures that the UAV remains within the current movement area 10 regardless of its posture after rotating around the direction of its tail to its head. When the current movement area 10 is used as the detection area for target obstacles, all obstacles that may collide with the UAV can be detected, thus preventing the UAV from colliding with obstacles after flipping over.

In this embodiment, the current movement area 10 of the UAV is cylindrical, and the diameter of the current movement area 10 is equal to or greater than the diameter of the smallest circumcircle of the UAV's projection on the preset plane. When the UAV maintains its current moving direction, it can always stay within the current movement area 10. This allows all obstacles that may collide with the UAV to be detected when the current movement area 10 is used as the detection area for target obstacles. It also avoids invalid prompts while obstacles can still be crossed, making the obstacle detection range match the actual travel range of the mobile device 1. This improves accuracy of obstacle prompts, reduces signal interference, and enhances user experience.

If the diameter of the current movement area 10 is equal to the diameter of the smallest circumcircle of the UAV's projection on the preset plane, the UAV may collide or scrape against obstacles outside the current movement area 10 after making slight directional adjustments. Users need to have advanced UAV flying skills to ensure that the UAV can successfully pass through small gaps between obstacles without displaying obstacle prompting information.

To address this issue, in some embodiments, the diameter of the current movement area 10 is a sum of the diameter of the smallest circumcircle and a preset minimum safety distance.

If the diameter of the current movement area 10 is set to be greater than the diameter of the smallest circumscribed circle, the diameter of the current movement area 10 can be a sum of the diameter of the smallest circumscribed circle and a preset minimum safety distance. The preset minimum safety distance is a minimum safety distance set to prevent the UAV from scraping or colliding due to operational errors or insufficient gaps between obstacles. The preset minimum safety distance can be set in advance based on experience. For example, the preset minimum safety distance can be 1/10 of the diameter of the smallest circumscribed circle.

In this embodiment, the diameter of the current movement area 10 is set to be the sum of the diameter of the smallest circumscribed circle and the preset minimum safety distance. This allows the diameter of the current movement area 10 to be slightly larger than the diameter of the smallest circumscribed circle, which is the maximum size of the UAV in the preset plane. This avoids the UAV from scraping or colliding due to operational errors or insufficient gaps between obstacles when the diameter of the current movement area 10 is the same as the diameter of the smallest circumscribed circle. This ensures flight safety when no obstacle prompting information is displayed and improves user experience.

In some embodiments, the obstacle prompting method further includes a step of changing the preset minimum safe distance in response to a user's adjustment operation on the preset minimum safe distance.

A user may adjust the preset minimum safe distance. When the user's adjustment is detected, the preset minimum safe distance is changed to alter the diameter of the current movement area 10, i.e., the obstacle detection range. For example, a user can adjust the distance by clicking an adjustment control on the interactive interface of display device 2. If the user's UAV flying skills are poor or the gaps between obstacles are small, the preset minimum safe distance can be increased to increase the diameter of the current movement area 10. If the user's flying skills are good or the gaps between obstacles are large, the preset minimum safe distance can be decreased to decrease the diameter of the current movement area 10.

In this embodiment, when a user's adjustment operation on the preset minimum safe distance is detected, the preset minimum safe distance is changed, so that the user can adjust the preset minimum safe distance by making an adjustment operation to adjust the diameter of the current movement area 10. This makes the diameter of the current movement area 10, i.e. the obstacle detection range, adaptable to the user's actual needs, ensuring operability and applicability of the obstacle prompting method and improving user experience.

In some embodiments, in response to presence of a target obstacle in the current movement area 10 of the mobile device 1, displaying obstacle prompting information in the prompting area 20 corresponding to the current movement area 10 in the real-time image includes the following steps: in response to the presence of a target obstacle in the current movement area 10 and the distance between the target obstacle and the mobile device 1 being less than a preset distance threshold, displaying obstacle prompting information in the prompting area 20, the obstacle prompting information being configured to prompt an outline shape of the target obstacle, or the obstacle prompting information being configured to prompt an outline shape of the prompting area 20.

If a target obstacle exists within the current movement area 10, the distance between the target obstacle and the mobile device 1 may be close or far. If the distance is far, the mobile device 1 can still maintain its current direction of movement. In this case, displaying obstacle prompting information in the prompting area 20 would be distracting to the user. Therefore, displaying obstacle prompting information in the prompting area 20 requires not only that a target obstacle exists within the current movement area 10, but also that the distance between the target obstacle and the mobile device 1 is less than a preset distance threshold, such as 10 meters.

In one embodiment, when a target obstacle is present in the current movement area 10 and the distance between the target obstacle and the mobile device 1 is less than a preset distance threshold, the obstacle prompting information displayed in the prompting area 20 can prompt an outline shape of the target obstacle or an outline shape of the prompting area 20. If the obstacle prompting information prompts the outline shape of the target obstacle, the user can visually observe the outline shape of the target obstacle based on the obstacle prompting information, determine the part of the target obstacle that may collide with the mobile device 1 based on the outline shape of the target obstacle, and determine appropriate obstacle avoidance direction. If the obstacle prompting information prompts the outline shape of the prompting area 20, the user can determine existence of a target obstacle within the current movement area 10 based on the obstacle prompting information, which avoids difficulty in determining the existence of a target obstacle within the current movement area 10 by observing the outline shape when the target obstacle is small.

In this embodiment, when a target obstacle exists within the current movement area 10 and the distance between the target obstacle and the mobile device 1 is less than a preset distance threshold, obstacle prompting information is displayed in the prompting area 20. This ensures that obstacle prompting information is only displayed when the mobile device 1 is close to the target obstacle and obstacle avoidance is required, thereby improving accuracy of obstacle promptings and reducing signal interference. The obstacle prompting information can prompt the outline shape of the target obstacle or the outline shape of the prompting area 20, allowing the user to intuitively observe the outline shape of the target obstacle or determine the presence of a target obstacle within the current movement area 10, and thus perform appropriate obstacle avoidance based on the prompting information.

In some embodiments, if the obstacle prompting information is configured to prompt the outline shape of the target obstacle, the obstacle prompting information is configured to prompt the outline shape of the target obstacle within the current movement area 10.

When the obstacle prompting information prompts the outline shape of a target obstacle, since the area displaying the obstacle prompting information, i.e., the prompting area 20, corresponds to the current movement area 10 of the mobile device 1, the outline shape of the target obstacle prompted is the outline shape of the target obstacle within the current movement area 10. If an obstacle is completely located within the current movement area 10, the outline shape displayed when the obstacle is the target obstacle is a complete outline shape of the obstacle. If an obstacle is partially located within the current movement area 10, the outline shape displayed when a portion of the obstacle is the target obstacle is the outline shape of the portion of the obstacle within the current movement area 10.

In some embodiments, if a proportion of the target obstacle within the prompting area 20 is greater than or equal to a preset proportion threshold, the obstacle prompting information is configured to prompt the outline shape of the target obstacle. If the proportion of the target obstacle within the prompting area 20 is less than the preset proportion threshold, the obstacle prompting information is configured to prompt the outline shape of the prompting area.

The display method of obstacle prompts can be determined based on the proportion of the target obstacle within the prompting area 20. This proportion can be determined using existing technologies. When the proportion of the target obstacle within the prompting area 20 is greater than or equal to a preset threshold, it indicates a larger target obstacle within the prompting area 20. In this case, the obstacle prompting information prompts the outline of the target obstacle, allowing the user to visually observe its shape. When the proportion of the target obstacle within the prompting area 20 is less than the preset threshold, it indicates a smaller target obstacle within the prompting area 20. If it is difficult to determine presence of a smaller target obstacle within the current movement area 10 by observing its outline, the obstacle prompt information prompts the outline of the prompting area 20, allowing the user to confirm the presence of a target obstacle within the current movement area.

In this embodiment, when the proportion of the target obstacle within the prompting area 20 is greater than or equal to a preset proportion threshold, the obstacle prompting information is configured to prompt the outline shape of the target obstacle. When the proportion of the target obstacle within the prompting area 20 is less than the preset proportion threshold, the obstacle prompting information is configured to prompt the outline shape of the prompting area 20. This allows the prompting method of the obstacle prompting information to be determined according to the size of the target obstacle. This enables the user to intuitively observe the outline shape of the target obstacle when it is large, and to determine whether there is a target obstacle in the current movement area 10 when the target obstacle is small, thus improving adaptability of the target obstacle prompting information in different scenarios.

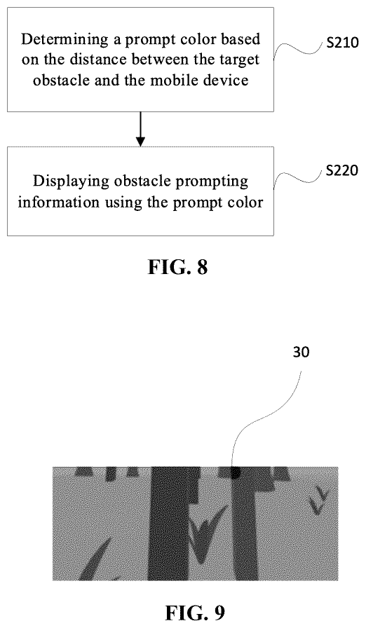

In some embodiments, as shown in FIG. 8, displaying obstacle prompting information in the prompting area 20 includes the following steps:
Step S210: determining a prompt color based on the distance between the target obstacle and the mobile device. Different prompt colors correspond to different distance ranges between the target obstacle and the mobile device.

In step S210, the distance between the target obstacle and the mobile device 1 can be determined by, for example, depth mapping technology, and a corresponding prompt color can be determined based on the distance between the target obstacle and the mobile device 1. Different prompt colors are used when the distance between the target obstacle and the mobile device 1 is within different preset distance ranges.

For example, when the distance between the target obstacle and the mobile device 1 is within a preset distance range of 5-10 meters, the corresponding prompt color is green. When the distance between the target obstacle and the mobile device 1 is within a preset distance range of 2-5 meters, the corresponding prompt color is yellow. When the distance between the target obstacle and the mobile device 1 is within a preset distance range of 0-2 meters, the corresponding prompt color is red.
Step S220: displaying obstacle prompting information using the prompt color.

In step S220, obstacle prompting information is displayed in a color corresponding to the distance between the current target obstacle and the mobile device 1. For example, when the distance between the target obstacle and the mobile device 1 is within a preset distance range of 0-2 meters, the obstacle prompting information can be displayed in red, so that the user can determine the preset distance range between the target obstacle and the mobile device 1 based on the display color of the obstacle prompting information, and thus determine when to avoid the obstacle.

In this embodiment, the prompt color is determined based on the distance between the target obstacle and the mobile device 1, and the obstacle prompt information is displayed in the prompt color. This allows the user to determine the preset distance range between the target obstacle and the mobile device 1 based on the displayed color of the obstacle prompt information, providing a basis for determining when to perform obstacle avoidance. This enables the user to control the distance between the mobile device 1 and the target obstacle in a timely manner, and the obstacle prompt information is clearer and more specific, thereby improving user experience.

In some embodiments, if the obstacle prompting information is configured to prompt the outline shape of a target obstacle, the obstacle prompting information is a prompt color block 30, and the prompt color block 30 has the same outline shape as the target obstacle. If the obstacle prompting information is configured to prompt the outline shape of a prompting area 20, the obstacle prompting information is a prompt line 40, and the prompt line 40 has the same outline shape as the prompting area 20.

In some embodiments, an obstacle prompt is configured to prompt the outline shape of the target obstacle or the outline shape of the prompting area 20. If the obstacle prompt is configured to prompt the outline shape of the target obstacle, the obstacle prompt can be a prompt color block 30. As shown in FIG. 9, the prompt color block 30 is a block-shaped area filled with a prompt color. The prompt color block 30 has the same outline shape as the target obstacle, that is, an periphery shape of the block-shaped area filled with the prompt color is the same as a periphery shape of the target obstacle within the current movement area 10. When the prompt color block 30 is displayed in the prompting area 20, the user can intuitively observe the outline shape of the target obstacle based on the outline shape of the prompt color block 30, and determine a preset distance range between the target obstacle and the mobile device 1 by the color of the prompt color block 30.

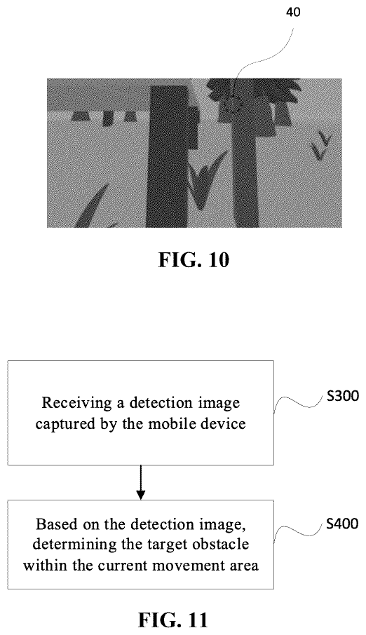

In some embodiment, if the obstacle prompt information is configured to prompt the outline shape of the prompting area 20, the obstacle prompt information can be a prompt line 40. As shown in FIG. 10, the prompt line 40 is a line with a prompt color and a preset line type. The prompt line 40 has the same outline shape as the prompting area 20. For example, when the prompting area 20 is circular in the real-time image, the prompt line 40 can be a circular dashed line with a prompt color. When the prompt line 40 is displayed in the prompting area 20, the user can determine existence of a target obstacle in the current movement area 10 based on the prompt line 40, and determine a preset distance range between the target obstacle and the mobile device 1 based on the color of the prompt line 40.

In this embodiment, the obstacle prompting information is set as a prompt color block 30 with the same outline shape as the target obstacle, or as a prompt line 40 with the same outline shape as the prompting area 20. The prompt color block 30 can prompt the outline shape of the target obstacle, or the prompt line 40 can prompt the presence of a target obstacle in the current movement area 10. The color of the prompt color block 30 or the prompt line 40 can prompt the preset distance range between the target obstacle and the mobile device 1. The obstacle prompting information is clearer and more specific, making it easier for a user to avoid obstacles and improving user experience.

In some embodiments, the obstacle prompting method further includes: determining the target obstacle within the current movement area 10.

If presence of a target obstacle within the current movement area 10 and a distance between the target obstacle and the mobile device 1 being less than a preset distance threshold are used as conditions for displaying obstacle prompt information, it is necessary to determine whether there is a target obstacle within the current movement area and the distance between the target obstacle and the mobile device 1. The target obstacle within the current movement area 10 can be determined first.

In some embodiments, as shown in FIG. 11, determining the target obstacle within the current movement area 10 includes the following steps:
Step S300: receiving a detection image captured by the mobile device.

In step S300, the display device 2 receives the detection image captured by the mobile device 1. The detection image can include an image corresponding to the current movement area 10 of the mobile device 1. When the mobile device 1 moves, the detection image captured by the mobile device 1 changes synchronously. For example, the mobile device 1 is a UAV, and the display device 2 is a pair of glasses. The detection image can be captured by a camera installed on the UAV, and image data corresponding to the detection image can be sent to the glasses so that the glasses can receive the detection image captured by the UAV.

It should be noted that both real-time footage and detection images can be captured by the camera on the mobile device 1. The real-time footage and detection images can be captured by the same camera on the mobile device 1, or they can be captured by different cameras on the mobile device 1.
Step S400: based on the detection image, determining the target obstacle within the current movement area.

In step S400, the display device 2 can determine the target obstacle in the current movement area 10 based on the received detection image, thereby determining that there is a target obstacle in the current movement area 10 and determining the distance between the target obstacle and the mobile device 1. As such, obstacle prompting information can be displayed in the prompting area 20 when the distance between the target obstacle and the mobile device 1 is less than a preset distance threshold.

In this embodiment, by receiving the detection image captured by the mobile device 1 and determining the target obstacle within the current mobile area 10 based on the detection image, the determination of the target obstacle is achieved. This provides a basis for judging whether a target obstacle exists within the current mobile area 10 and for determining the distance between the target obstacle and the mobile device 1. This allows for subsequent determination of whether to display obstacle prompting information based on the determination results and distance comparison. Determining the target obstacle within the current mobile area 10 based on the detection image captured by the mobile device 1 ensures accuracy of the target obstacle determination, thereby improving accuracy of obstacle promptings and enhancing user experience.

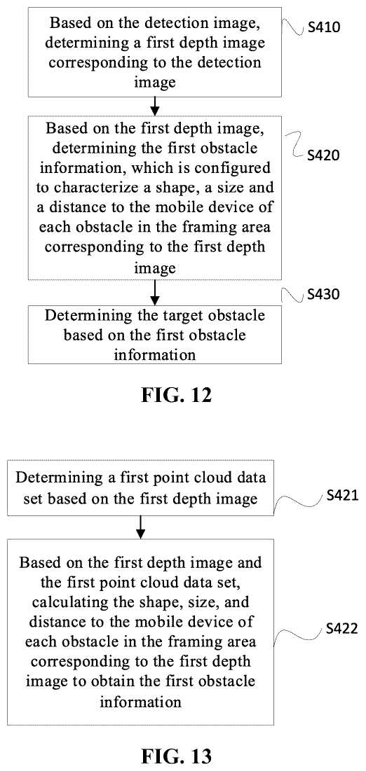

In some embodiments, as shown in FIG. 12, if the obstacle prompting information is configured to prompt the outline shape of the target obstacle, determining the target obstacle within the current movement area 10 based on the detection image may include the following steps:
Step S410: based on the detection image, determining a first depth image corresponding to the detection image.

In step S410, a depth map is an image that can represent a distance between objects in a scene and the camera. For example, a grayscale value of a pixel in the depth map can represent a distance between the object corresponding to that pixel and the camera. A first depth image corresponding to the detection image can be determined based on the received detection image captured by the mobile device 1. A framing area of the detection image is the same as that of the first depth image. For example, the detection image can be converted into a first depth image by running a preset algorithm. The first depth image can represent the distance between each obstacle in the framing area corresponding to the detection image and the mobile device 1.
Step S420: based on the first depth image, determining the first obstacle information, which is configured to characterize a shape, a size and a distance to the mobile device of each obstacle in the framing area corresponding to the first depth image.

In step S420, the first obstacle information can be determined based on the first depth image corresponding to the detection image. When the obstacle prompting information is configured to prompt the outline shape of the target obstacle, it is necessary not only to determine the distance between the target obstacle and the mobile device 1, but also to determine the shape and size of the target obstacle. Therefore, it is necessary to ensure that the first obstacle information can characterize the shape, size, and distance to the mobile device 1 of each obstacle in the framing area corresponding to the first depth image, i.e., the framing area corresponding to the detection image.
Step S430: determining the target obstacle based on the first obstacle information.

In step S430, an obstacle can be identified as a target obstacle based on the shape, size, and distance to the mobile device 1 of each obstacle in the framing area corresponding to the first depth image characterized by the first obstacle information.

In this embodiment, a first depth image corresponding to the detection image is determined based on the detection image, and first obstacle information is determined based on the first depth image. This allows for the identification of a target obstacle based on the first obstacle information, providing a basis for determining whether a target obstacle exists within the current movement area 10 and the distance between the target obstacle and the mobile device 1. This enables subsequent determination of whether to display obstacle prompting information based on the determination result and distance comparison. By converting the detection image into a first depth image, it is convenient to extract the shape, size, and distance to the mobile device 1 of each obstacle from the first depth image, ensuring accuracy of target obstacle identification and thus improving accuracy of obstacle prompting and enhancing user experience.

In some embodiments, as shown in FIG. 13, determining the first obstacle information based on the first depth image includes the following steps:
Step S421: determining a first point cloud data set based on the first depth image.

In step S421, a first point cloud data set can be determined based on the first depth image corresponding to the detection image using point cloud technology and algorithms. A point cloud is a collection of points in a three-dimensional space of the real world. Point cloud technology and algorithms can capture physical characteristics of the real world corresponding to the depth image based on the depth image and digitize them. The resulting first point cloud data set includes spatial coordinates, reflection intensity, and other data of each point in the framing area corresponding to the first depth image, i.e., the framing area of the detection image.
Step S422: based on the first depth image and the first point cloud data set, calculating the shape, size, and distance to the mobile device of each obstacle in the framing area corresponding to the first depth image to obtain the first obstacle information.

In step S422, based on the determined first point cloud data set, the shape and size of each obstacle in the framing area corresponding to the first depth image (i.e., the framing area corresponding to the detection image) can be calculated, and the distance between each obstacle and the mobile device 1 can be determined based on the first depth image. For example, based on the spatial coordinates and reflection intensity of each point included in the first point cloud data set, a set of points with similar spatial coordinates and the same reflection intensity can be identified as an obstacle. This determines the shape and size of each obstacle, and the distance between each obstacle and the mobile device 1 is determined based on the first depth image, thus obtaining the first obstacle information.

In some embodiments, determining the target obstacle based on the first obstacle information includes the following steps: based on the first obstacle information, determining the obstacle with the shortest distance to the mobile device 1 in the current movement area 10 as the target obstacle.

After obtaining the first obstacle information, since the first obstacle information represents the shape, size, and distance to the mobile device 1 of each obstacle within the framing area corresponding to the first depth image (i.e., the framing area corresponding to the detection image), and this framing area is larger than the current movement area 10 of the mobile device 1, it is possible to select only obstacles located within the current movement area 10. The obstacle with the shortest distance to the mobile device 1 within the current movement area 10 is selected as the target obstacle, thus achieving the determination of the target obstacle.

In this embodiment, a first point cloud data set is determined based on a first depth image. Then, based on the first depth image and the first point cloud data set, the shape, size, and distance to the mobile device 1 of each obstacle in the framing area corresponding to the first depth image are calculated to obtain first obstacle information. This determination of the first obstacle information provides a basis for identifying the target obstacle, and the accuracy of the first obstacle information is ensured by using point cloud technology and point cloud algorithms. Based on the first obstacle information, the obstacle with the shortest distance to the mobile device 1 in the current movement area 10 is identified as the target obstacle. This determination of the target obstacle provides a basis for whether to display obstacle prompting information, enabling the obstacle prompting information to highlight the target obstacle with the shortest distance to the mobile device 1, i.e., the obstacle most in need of obstacle avoidance, thus ensuring obstacle avoidance safety and improving user experience.

It is understandable that if the target obstacle is determined by determining the first depth image corresponding to the detection image and determining the first obstacle information based on the first depth image, the calculation of determining the first depth image and the first obstacle information is large due to the large framing area of the detection image, which may result in a slow response speed.

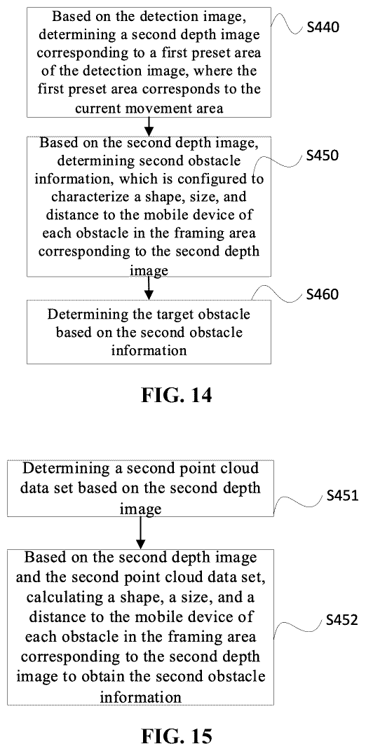

Therefore, in some embodiments, as shown in FIG. 14, if the obstacle prompting information is configured to prompt the outline shape of the target obstacle, determining the target obstacle within the current movement area 10 based on the detection image may further include the following steps:
Step S440: based on the detection image, determining a second depth image corresponding to a first preset area of the detection image, where the first preset area corresponds to the current movement area.

In step S440, the depth map is an image that can represent a distance between objects in the scene and the camera. For example, a grayscale value of a pixel in the depth map can represent the distance between the object corresponding to that pixel and the camera. Based on the detection image captured by the mobile device 1, a second depth image corresponding to a first preset region of the detection image can be determined. The first preset area corresponds to the current movement area 10, ensuring that the framing area corresponding to the second depth image is the same as the current movement area 10. For example, a preset algorithm can be used to convert the detection image into a second depth image, which can represent the distance between each obstacle in the current movement area 10 and the mobile device 1.
Step S450: based on the second depth image, determining second obstacle information, which is configured to characterize a shape, size, and distance to the mobile device of each obstacle in the framing area corresponding to the second depth image.

In step S450, the second obstacle information can be determined based on the second depth image corresponding to the preset area of the detection image. When the obstacle prompting information is configured to prompt the outline shape of the target obstacle, it is necessary not only to determine the distance between the target obstacle and the mobile device 1, but also to determine the shape and size of the target obstacle. Therefore, it is necessary to ensure that the second obstacle information can characterize the shape, size and distance of each obstacle in the current movement area 10 corresponding to the second depth image.
Step S460: determining the target obstacle based on the second obstacle information.

In step S460, an obstacle can be identified as a target obstacle based on the shape, size, and distance between each obstacle and the mobile device 1 in the framing area corresponding to the second depth image characterized by the second obstacle information.

In this embodiment, a second depth image corresponding to a preset area of the detection image is determined based on the detection image, and second obstacle information is determined based on the second depth image. This allows for identification of the target obstacle based on the second obstacle information, providing a basis for determining whether a target obstacle exists within the current movement area 10 and the distance between the target obstacle and the mobile device 1. This enables subsequent determination of whether to display obstacle prompting information based on the determination result and distance comparison. By converting the detection image into a second depth image, it is easier to extract the shape, size, and distance of each obstacle from the second depth image, ensuring accuracy of target obstacle identification and thus improving accuracy of obstacle prompt and enhancing user experience. Furthermore, the second depth image corresponds only to the first preset area of the detection image, reducing computational load in the determination process of the second depth image and second obstacle information, thereby improving response speed.

In some embodiments, as shown in FIG. 15, determining the second obstacle information based on the second depth image includes the following steps:
Step S451: determining a second point cloud data set based on the second depth image.

In step S451, a second point cloud data set can be determined based on the second depth image corresponding to the preset area of the detection image, using point cloud technology and algorithms. A point cloud is a set of points in a three-dimensional space of the real world. Point cloud technology and algorithms can capture physical characteristics of the real world corresponding to the depth image based on the depth image and digitize them. The resulting second point cloud data set includes spatial coordinates, reflection intensity, and other data of each point in the framing area corresponding to the second depth image, i.e., the current movement area 10.
Step S452: based on the second depth image and the second point cloud data set, calculating a shape, a size, and a distance to the mobile device of each obstacle in the framing area corresponding to the second depth image to obtain the second obstacle information.

In step S452, based on the determined second point cloud data set, the shape and size of each obstacle in the framing area corresponding to the second depth image, i.e., the current movement area 10, can be calculated, and the distance between each obstacle and the mobile device 1 can be determined based on the second depth image. For example, based on the spatial coordinates and reflection intensity of each point included in the second point cloud data set, a set of points with similar spatial coordinates and the same reflection intensity can be identified as an obstacle, thereby determining the shape and size of each obstacle, and determining the distance between each obstacle and the mobile device 1 based on the second depth image to obtain the second obstacle information.

In some embodiments, determining the target obstacle based on the second obstacle information includes the following steps: based on the second obstacle information, determining an obstacle with the shortest distance to the mobile device 1 in the current movement area 10 as the target obstacle.

After obtaining the second obstacle information, since the second obstacle information represents the shape, size, and distance to the mobile device 1 of each obstacle in the framing area corresponding to the second depth image, i.e. the current movement area 10, the obstacle can be directly selected from these obstacles. The obstacle with the shortest distance to the mobile device 1 in the current movement area 10 is selected as the target obstacle, thus realizing determination of the target obstacle.

In this embodiment, a second point cloud data set is determined based on the second depth image. Then, the shape, size, and distance to the mobile device 1 of each obstacle in the framing area corresponding to the second depth image are calculated based on the second depth image and the second point cloud data set, thus obtaining second obstacle information. This determination of the second obstacle information provides a basis for identifying the target obstacle, and the accuracy of the second obstacle information is ensured by using point cloud technology and point cloud algorithms. Based on the second obstacle information, the obstacle with the shortest distance to the mobile device 1 in the current movement area 10 is identified as the target obstacle. This determination of the target obstacle provides a basis for whether to display obstacle prompting information, enabling the obstacle prompting information to highlight the target obstacle with the shortest distance to the mobile device 1, i.e., the obstacle most in need of requiring obstacle avoidance, ensuring obstacle avoidance safety and improving user experience.

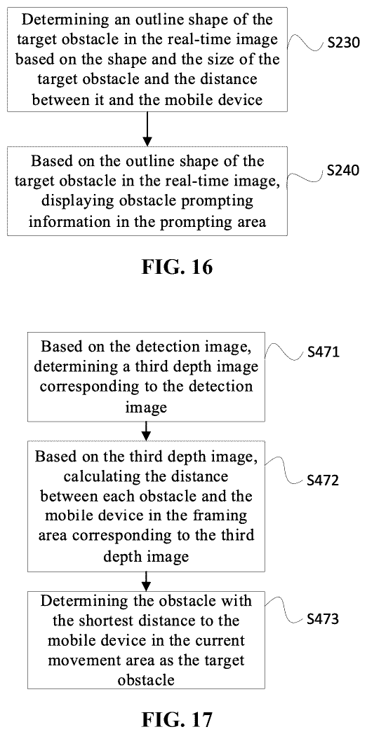

In some embodiments, if the obstacle prompting information is configured to prompt the outline shape of a target obstacle, as shown in FIG. 16, displaying the obstacle prompting information in the prompting area 20 includes the following steps:
Step S230: determining an outline shape of the target obstacle in the real-time image based on the shape and the size of the target obstacle and the distance between it and the mobile device.

In step S230, the first obstacle information or the second obstacle information used as the basis for determining the target obstacle can both characterize the shape, size and distance to the mobile device 1 of the target obstacle. The outline shape of the target obstacle in the real-time image can be determined based on the actual shape, size and distance to the mobile device 1 of the target obstacle.
Step S240: based on the outline shape of the target obstacle in the real-time image, displaying obstacle prompting information in the prompting area.

In step S240, obstacle prompting information prompting the outline shape of the target obstacle can be displayed in the prompting area 20 based on the outline shape of the target obstacle in the real-time image. For example, the outline shape and prompt color of the target obstacle in the real-time image can be determined first based on the actual shape, size, and distance to the mobile device 1 of the target obstacle represented by the first obstacle information or the second obstacle information. Then, the outline shape of the prompt color block 30 can be determined based on the outline shape of the target obstacle in the real-time image, so that the prompt color block 30 with that outline shape and prompt color can be displayed in the prompting area 20.

In this embodiment, the outline shape of the target obstacle in the real-time image is determined based on the shape and the size of the target obstacle and its distance to the mobile device 1. Obstacle prompting information is then displayed in the prompting area 20 based on the outline shape of the target obstacle in the real-time image. This makes the obstacle prompting information clearer and more specific, allowing users to easily use the obstacle prompting information to avoid the obstacle and improving user experience.

In some embodiments, as shown in FIG. 17, if obstacle prompting information is configured to prompt the outline shape of the prompting area, determining the target obstacle 10 within the current movement area based on the detection image may include the following steps:
Step S471: based on the detection image, determining a third depth image corresponding to the detection image.

In step S471, the depth map is an image that can represent the distance between an object in the scene and the camera. For example, a grayscale value of a pixel in the depth map can represent the distance between the object corresponding to that pixel and the camera. A third depth image can be determined based on the detection image captured by the mobile device 1, and the framing area of the detection image is the same as that of the third depth image. For example, the detection image can be converted into a third depth image by running a preset algorithm. The third depth image can represent the distance between each obstacle in the framing area corresponding to the detection image and the mobile device 1.
Step S472: based on the third depth image, calculating the distance between each obstacle and the mobile device in the framing area corresponding to the third depth image.

In step S472, when the obstacle prompting information is configured to prompt the outline shape of the prompting area, it is to indicate whether there is a target obstacle in the current movement area 10. It is not necessary to determine the shape and size of the target obstacle through point cloud technology. It is only necessary to determine the distance between the target obstacle and the mobile device. The distance between each obstacle in the third depth image and the mobile device 1 can be determined based on the third depth image.
Step S473: determining the obstacle with the shortest distance to the mobile device in the current movement area as the target obstacle.

In step S473, since the framing area corresponding to the third depth image, i.e. the framing area corresponding to the detection image, is larger than the current movement area 10 of the mobile device 1, it is necessary to select obstacles located in the current movement area 10. The obstacle with the shortest distance to the mobile device 1 in the current movement area 10 is selected as the target obstacle, thus realizing the determination of the target obstacle.

In this embodiment, a corresponding third depth image is determined based on the detection image, and the distance between each obstacle in the corresponding framing area and the mobile device 1 is calculated based on the third depth image. The obstacle with the shortest distance to the mobile device 1 in the current movement area 10 is then selected as the target obstacle. This provides a basis for determining whether a target obstacle exists in the current movement area 10 and for determining the distance between the target obstacle and the mobile device 1. This allows for subsequent determination of whether to display obstacle prompting information based on the determination result and distance comparison. By converting the detection image into a third depth image, it is easier to extract the distance between each obstacle and the mobile device 1 using the third depth image, ensuring accuracy of target obstacle determination and thus improving accuracy of obstacle prompting and enhancing user experience.

It is understandable that if the target obstacle is determined by determining the third depth image corresponding to the detection image and then determining the target obstacle based on the third depth image, the calculation of the process of determining the third depth image and the distance between each obstacle and the mobile device 1 is large due to the large framing area of the detection image, which may result in a slow response speed.

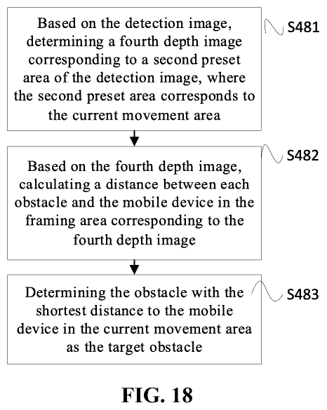

Therefore, in some embodiments, as shown in FIG. 18, if the obstacle prompting information is configured to prompt the outline shape of the prompting area 20, determining the target obstacle within the current movement area 10 based on the detection image may include the following steps:
Step S481: based on the detection image, determining a fourth depth image corresponding to a second preset area of the detection image, where the second preset area corresponds to the current movement area.

In step S481, the depth map is an image that can represent the distance between objects in the scene and the camera. For example, a grayscale value of a pixel in the depth map can represent the distance between the object corresponding to that pixel and the camera. Based on the detection image captured by the mobile device 1, a fourth depth image corresponding to a second preset area of the detection image can be determined. The second preset area corresponds to the current movement area 10, ensuring that the framing area corresponding to the fourth depth image is the same as the current movement area 10. For example, a preset algorithm can be used to convert the detection image into a fourth depth image, which can represent the distance between each obstacle in the current movement area 10 and the mobile device 1.
Step S482: based on the fourth depth image, calculating a distance between each obstacle and the mobile device in the framing area corresponding to the fourth depth image.

In step S482, when the obstacle prompting information is configured to prompt the outline shape of the target obstacle, it is to indicate whether there is a target obstacle in the current movement area 10. It is not necessary to determine the shape and size of the target obstacle through point cloud technology. It is only necessary to determine the distance between the target obstacle and the mobile device. The distance between each obstacle in the fourth depth image and the mobile device 1 can be determined based on the fourth depth image.
Step S483: determining the obstacle with the shortest distance to the mobile device in the current movement area as the target obstacle.

In step S483, since the framing area corresponding to the fourth depth image is the same as the current movement area 10, it is possible to directly select from these obstacles and take the obstacle with the shortest distance to the mobile device 1 in the current movement area 10 as the target obstacle, realizing the determination of the target obstacle.

In this embodiment, a corresponding fourth depth image is determined based on the detection image, and the distance between each obstacle in the corresponding framing area and the mobile device 1 is calculated based on the fourth depth image. The obstacle with the shortest distance to the mobile device 1 in the current movement area 10 is then selected as the target obstacle. This provides a basis for determining whether a target obstacle exists in the current movement area 10 and for determining the distance between the target obstacle and the mobile device 1, enabling subsequent determination of whether to display obstacle prompting information based on the determination result and distance comparison. By converting the detection image into a fourth depth image, it is easier to extract the distance between each obstacle and the mobile device 1 using the fourth depth image, ensuring accuracy of target obstacle determination and thus improving accuracy of obstacle prompting and enhancing user experience. Furthermore, the fourth depth image corresponds only to the second preset area, reducing the computational load of determining the fourth depth image and the distance between each obstacle and the mobile device 1, and improving response speed. In some embodiments, the detection image is captured by a binocular camera of the mobile device 1.

The detection image can be captured by a binocular camera set on the mobile device 1. The binocular camera can use two cameras to simulate human stereoscopic vision. The depth information can be calculated by the difference between the images captured by the two cameras, so as to determine the corresponding first depth image or second depth image based on the detection image.

In this embodiment, the detection image is captured by the binocular camera of the mobile device 1, which makes it easier to determine the first depth image corresponding to the detection image or the second depth image corresponding to a preset area of the detection image based on the detection image. This reduces the amount of calculation in the process of determining the target obstacle and ensures accuracy of determining the target obstacle, thereby improving the response speed and accuracy of obstacle prompts.

In some embodiments, the mobile device 1 is communicatively connected to the remote control device 3, which is used to control the current moving direction of the mobile device 1.

In this embodiment, the mobile device 1 is communicatively connected to the remote control device 3. The mobile device 1 can adjust its current direction of movement in response to the user's control operation on the remote control device 3, so that the user can control the current direction of movement of the mobile device 1 to avoid obstacles through the remote control device 3 according to the obstacle prompting information.

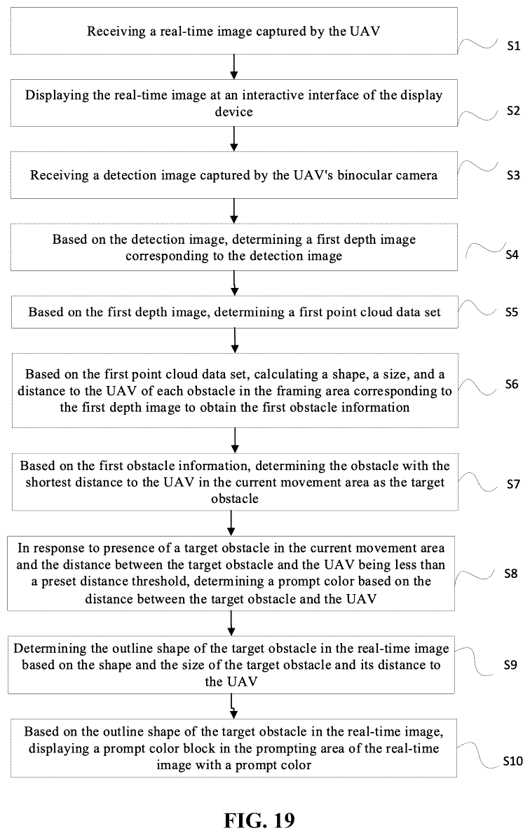

In one exemplary embodiment, an obstacle prompting method is provided for display device 2, as shown in FIG. 19. The obstacle prompting method includes the following steps:
Step S1: receiving a real-time image captured by the UAV;
Step S2: displaying the real-time image at an interactive interface of the display device;
Step S3: receiving a detection image captured by the UAV's binocular camera;
Step S4: based on the detection image, determining a first depth image corresponding to the detection image;
Step S5: based on the first depth image, determining a first point cloud data set;
Step S6: based on the first point cloud data set, calculating a shape, a size, and a distance to the UAV of each obstacle in the framing area corresponding to the first depth image to obtain the first obstacle information;
Step S7: based on the first obstacle information, determining the obstacle with the shortest distance to the UAV in the current movement area as the target obstacle;
Step S8: in response to presence of a target obstacle in the current movement area and the distance between the target obstacle and the UAV being less than a preset distance threshold, determining a prompt color based on the distance between the target obstacle and the UAV. Different prompt colors correspond to different preset distance ranges of the distance between the target obstacle and the UAV.
Step S9: determining the outline shape of the target obstacle in the real-time image based on the shape and the size of the target obstacle and its distance to the UAV;
Step S10: based on the outline shape of the target obstacle in the real-time image, displaying a prompt color block in the prompting area of the real-time image with a prompt color. The prompting area in the real-time image corresponds to the current movement area of the mobile device, and the prompt color block is the same as the outline shape of the target obstacle.

In this embodiment, by receiving a real-time image captured by a UAV, the image can be displayed at the interactive interface of display device 2. When a target obstacle exists within the UAV's current movement area 10 and the distance between the target obstacle and the mobile device 1 is less than a preset distance threshold, obstacle prompting information is displayed in the prompting area 20 corresponding to the current movement area 10 in the real-time image, thus achieving automatic obstacle prompting. By using the current movement area 10 of the mobile device 1 as the determination area for the existence of a target obstacle and displaying obstacle prompting information in the corresponding prompting area 20, the detection range and the prompting range of the obstacle are adapted to the actual movement range of the mobile device 1, thereby improving accuracy of obstacle prompting, reducing signal interference, and enhancing user experience.

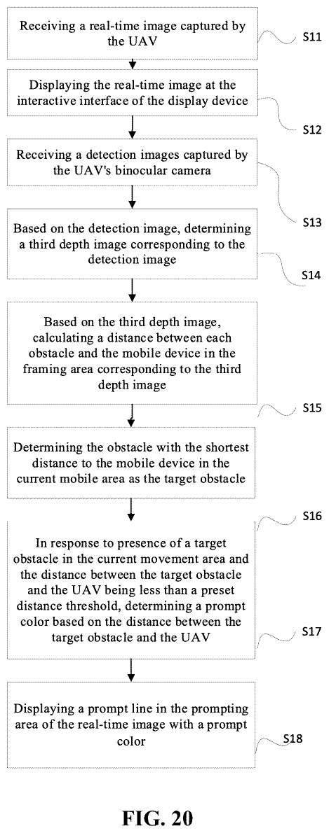

In one exemplary embodiment, an obstacle prompting method is provided for display device 2, as shown in FIG. 20. The obstacle prompting method includes the following steps:
Step S11: receiving a real-time image captured by the UAV;
Step S12: displaying the real-time image at the interactive interface of the display device;
Step S13: receiving a detection images captured by the UAV's binocular camera;
Step S14: based on the detection image, determining a third depth image corresponding to the detection image;
Step S15: based on the third depth image, calculating a distance between each obstacle and the mobile device in the framing area corresponding to the third depth image;
Step S16: determining the obstacle with the shortest distance to the mobile device in the current mobile area as the target obstacle;
Step S17: in response to presence of a target obstacle in the current movement area and the distance between the target obstacle and the UAV being less than a preset distance threshold, determining a prompt color based on the distance between the target obstacle and the UAV. Different prompt colors correspond to different preset distance ranges of the distance between the target obstacle and the UAV.
Step S18: displaying a prompt line in the prompting area of the real-time image with a prompt color. The prompting area in the real-time image corresponds to the current movement area of the mobile device, and the prompt line has the same outline shape as the prompting area.

In this embodiment, by receiving a real-time image captured by a UAV, the image can be displayed at the interactive interface of display device 2. When a target obstacle exists within the UAV's current movement area 10 and the distance between the target obstacle and the mobile device 1 is less than a preset distance threshold, obstacle prompting information is displayed in the prompting area 20 corresponding to the current movement area 10 in the real-time image, thus achieving automatic obstacle prompting. By using the current movement area 10 of the mobile device 1 as the determination area for the existence of a target obstacle and displaying obstacle prompting information in the corresponding prompting area 20, the detection range and the prompting range of the obstacle are adapted to actual moving range of the mobile device 1, thereby improving accuracy of obstacle prompting, reducing signal interference, and enhancing user experience.

In one exemplary embodiment, an obstacle prompting method is provided for a mobile device 1. The obstacle prompting method includes the following steps: sending a captured real-time image to a display device 2, so that the display device executes the obstacle prompting method as described above.

In this system, the mobile device 1 can be, for example, a UAV. The mobile device 1 can capture a real-time image using its camera and send the captured image to the display device 2. The display device 2 can then display the real-time image at its interactive interface. When a target obstacle exists within the current movement area 10 of the mobile device 1, obstacle prompting information is displayed in the prompting area 20 corresponding to the current movement area 10 in the real-time image, thus achieving automatic obstacle prompting. The obstacle prompting method executed by the display device 2 after receiving the real-time image sent by the mobile device 1 has been described in the above embodiments and will not be repeated here.

In some embodiments, the detection and determination of a target obstacle within the current movement area 10 can be performed by the display device 2 as described in the above embodiments, that is, the display device 2 receives the detection image captured and sent by the mobile device 1, and the display device 2 determines the target obstacle within the current movement area 10 based on the detection image.

In other embodiments, the obstacle prompting method for the mobile device 1 further includes: determining a target obstacle within the current movement area 10, and sending the determination result of the target obstacle to the display device 2. Determining the target obstacle within the current movement area 10 includes: determining the target obstacle within the current movement area 10 based on the detection image.

The detection and determination of the target obstacle within the current movement area 10 can also be performed by the mobile device 1. That is, the mobile device 1 directly determines the target obstacle within the current movement area 10 based on the detection images it captures, and sends the determination result of the target obstacle to the display device 2, so that the display device 2 can display obstacle prompting information based on the determination result of the target obstacle. The steps of the mobile device 1 determining the target obstacle within the current movement area 10 based on the detection images are similar to those of the display device 2, and have been described in the above embodiments, and will not be repeated here. In an exemplary embodiment, a computing device is provided, including a first processor, a first memory, and a display. The first memory stores a computing program, and when the first processor executes the computing program, the first processor and the display implement any of the steps of the obstacle prompting method for the display device 2 described above.

In one exemplary embodiment, a computing-readable storage medium is provided having a computing program stored thereon, which, when executed by a first processor, implements the steps of any of the above-described obstacle prompting methods for a display device 2. The computing-readable storage medium may be a ROM, random access memory (RAM), CD-ROM, magnetic tape, floppy disk, or optical data storage device, etc.

In one exemplary embodiment, a mobile device 1 is provided, including a second processor, a second memory, and a camera. The second memory stores a computing program. When the second processor executes the computing program, it can send real-time images captured by the camera to a display device 2, so that the display device 2 can execute any of the steps of the obstacle prompting method described above for the display device 2.

In some embodiments, when the second processor executes a computing program, it enables the mobile device to perform any of the steps of the obstacle prompting method described above for the mobile device 1.

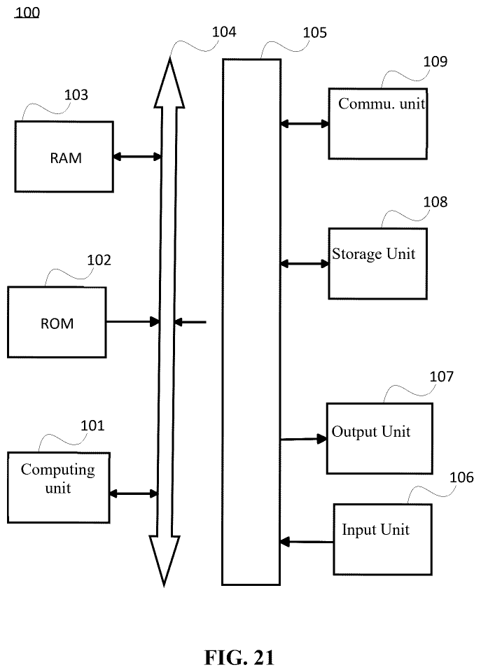

FIG. 21 shows a structural block diagram of a computing device 100 that can serve as the display device 2 of this disclosure. The computing device 100 includes a computing unit 101, which can perform various appropriate actions and processes based on a computing program stored in a read-only memory (ROM) 102 or a computing program loaded from a storage unit 108 into a random access memory (RAM) 103. The RAM 103 may also store various programs and data required for the operation of the computing device 100. The computing unit 101, ROM 102, and RAM 103 are interconnected via a bus 104. An input/output (I/O) interface 105 is also connected to the bus 104.

Multiple components in the computing device 100 are connected to I/O interface 105, including: input unit 106, output unit 107, storage unit 108, and communication unit 109. Input unit 106 can be any type of device capable of inputting information to the computing device 100. Input unit 106 can receive input numerical or character information and generate key signal inputs related to user settings and/or function control of computing device 100, and may include, but is not limited to, a mouse, keyboard, touchscreen, trackpad, trackball, joystick, microphone, and/or remote control. Output unit 107 can be any type of device capable of presenting information, and may include, but is not limited to, a monitor, speaker, video/audio output terminal, vibrator, and/or printer. Storage unit 108 may include, but is not limited to, a hard disk and an optical disk. Communication unit 109 allows computing device 100 to exchange information/data with other devices through computing networks such as the Internet and/or various telecommunications networks, and may include, but is not limited to, modems, network cards, infrared communication devices, wireless communication transceivers, and/or chipsets, such as Bluetooth™ devices, WiFi devices, WiMax devices, cellular communication devices, and/or the like.

The computing unit 101 can be a variety of general-purpose and/or special-purpose processing components or circuitry with processing and computing capabilities. Some examples of the computing unit 101 include, but are not limited to, a central processing unit (CPU), a graphics processing unit (GPU), various special-purpose artificial intelligence (AI) computing chips, various computing units running machine learning model algorithms, a digital signal processor (DSP), and any suitable processor, controller, microcontroller, or circuitry etc. The computing unit 101 performs the various methods and processes described above, such as obstacle prompting methods. For example, in some embodiments, the obstacle prompting method may be implemented as a computing software program tangibly contained in a machine-readable medium, such as storage unit 108. In some embodiments, a part or all of the computing program may be loaded and/or installed on the computing device 100 via ROM 102 and/or communication unit 109. When the computing program is loaded into RAM 103 and executed by the computing unit 101, one or more steps of the obstacle prompting method described above may be performed. Alternatively, in other embodiments, the computing unit 101 may be configured to perform the obstacle prompting method by any other suitable means (e.g., by means of firmware).

The computing device 100 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the obstacle prompting method described above.

The various embodiments or implementation methods described in this specification are presented in a progressive manner. Each embodiment focuses on the differences from other embodiments, and the same or similar parts between the embodiments can be referred to each other.

In the description of this specification, references to the terms “embodiment,” “exemplary embodiment,” etc., refer to specific features, structures, materials, or characteristics described in connection with implementation methods or examples that are included in at least one implementation method or example of this disclosure.

In this specification, the illustrative expressions of the terms used do not necessarily refer to the same implementation or example. Furthermore, the specific features, structures, materials, or characteristics described may be combined in any suitable manner in one or more implementations or examples.

It is understood that the terms “first,” “second,” etc., as used in this disclosure may be used to describe various structures, but these structures are not limited by these terms. These terms are only used to distinguish one structure from another.

In one or more accompanying drawings, the same elements are represented by similar reference numerals. For clarity, many parts in the drawings are not drawn to scale. Furthermore, certain well-known parts may not be shown. For simplicity, a structure obtained after several steps may be depicted in a single drawing. Many specific details of this disclosure, such as the structure, materials, dimensions, processing methods, and techniques of the devices, are described below to provide a clearer understanding of the disclosure. However, as those skilled in the art will understand, this disclosure may be implemented without adhering to these specific details.

Finally, it should be noted that the above embodiments are only used to illustrate the technical solutions of this disclosure, and are not intended to limit them. Although this disclosure has been described in detail with reference to the foregoing embodiments, those skilled in the art should understand that modifications can still be made to the technical solutions described in the foregoing embodiments, or equivalent substitutions can be made to some or all of the technical features therein. Such modifications or substitutions do not cause the essence of the corresponding technical solutions to deviate from the scope of the technical solutions of the embodiments of this disclosure.

### INDUSTRIAL APPLICABILITY

In the obstacle prompting method, computing device, and medium provided in this disclosure, a real-time image captured by a mobile device is received and displayed at an interactive interface of a display device. When a target obstacle exists within the current movement area of the mobile device, obstacle prompting information is displayed in the prompting area corresponding to the current movement area in the real-time image, thus achieving automatic obstacle prompting. By using the current movement area of the mobile device as the determination area for the existence of a target obstacle and displaying obstacle prompting information in the corresponding prompting area, the detection range and the prompting range of the obstacle are adapted to the actual movement range of the mobile device, thereby improving accuracy of obstacle prompting, reducing signal interference, and enhancing user experience.

What is claimed is:

1. A computing device, comprising:
a memory, a processor, and a display,
wherein the memory stores a computing program, and when the computing program is executed by the processor, the processor is configured to perform:
receiving a real-time image;
displaying the real-time image; and
in response to presence of a target obstacle in a current movement area of the mobile structure, displaying obstacle prompting information in a prompting area.

2. The computing device according to claim 1, wherein the real-time image is captured by a mobile structure, which is a UAV, the real-time image is displayed at an interactive interface of the display, and the prompting area corresponds to the current movement area in the real-time image, the current movement area is in a cylindrical shape, an axis of the current movement area is parallel to a current moving direction of the UAV, and a bottom surface of the cylindrical shape is configured such that a smallest circumcircle of a projection of the UAV onto a preset plane is inside an area of the bottom surface, and the preset plane is perpendicular to a direction from a tail to a head of the UAV.

3. The computing device according to claim 2, wherein a diameter of the bottom surface of the current movement area is equal to or greater than a diameter of the smallest circumcircle of the projection of the UAV onto the preset plane.

4. The computing device according to claim 3, wherein the diameter of the current movement area is a sum of the diameter of the smallest circumcircle and a preset minimum safety distance.

5. The computing device according to claim 4, the processor is further configured to perform:
in response to a user's adjustment operation on the preset minimum safe distance, adjusting the preset minimum safe distance.

6. The computing device according to claim 1, wherein, in response to the presence of the target obstacle in the current movement area of the mobile structure, the displaying obstacle prompting information in the prompting area corresponding to the current movement area in the real-time image includes:
in response to the presence of the target obstacle in the current movement area and a distance between the target obstacle and the mobile structure being less than a preset distance threshold, displaying the obstacle prompting information in the prompting area,
wherein the obstacle prompting information is configured to prompt an outline shape of the target obstacle or an outline shape of the prompting area.

7. The computing device according to claim 6, wherein in a case that the obstacle prompting information is configured to prompt the outline shape of the target obstacle, the obstacle prompting information is configured to prompt the outline shape of the target obstacle in the current movement area.

8. The computing device according to claim 6, wherein in a case that a proportion of the target obstacle in the prompting area is greater than or equal to a preset proportion threshold, the obstacle prompting information is configured to prompt the outline shape of the target obstacle; and
in a case that the proportion of the target obstacle in the prompting area is less than the preset proportion threshold, the obstacle prompting information is configured to prompt the outline shape of the prompting area.

9. The computing device according to claim 6, wherein the displaying the obstacle prompting information in the prompting area includes:
determining a prompt color based on the distance between the target obstacle and the mobile device, wherein different prompt colors correspond to different distance ranges between the target obstacle and the mobile device; and
displaying the obstacle prompting information using the prompt color.

10. The computing device according to claim 6, wherein in a case that the obstacle prompting information is configured to prompt the outline shape of the target obstacle, the obstacle prompting information is a prompting color block, and the prompting color block has the same outline shape as the target obstacle; and
in a case that the obstacle prompting information is configured to prompt the outline shape of the prompting area, the obstacle prompting information is a prompt line, and the prompt line has the same outline shape as the prompting area.

11. The computing device according to claim 6, wherein the processor is further configured to perform:
determining the target obstacle in the current movement area;
wherein the determining the target obstacle in the current movement area comprises:
receiving a detection image captured by the mobile structure; and
determining the target obstacle in the current movement area based on the detection image.

12. The computing device according to claim 11, wherein, in a case that the obstacle prompting information is configured to prompt the outline shape of the target obstacle, the determining the target obstacle in the current movement area based on the detection image includes:
determining a first depth image corresponding to the detection image based on the detection image;
determining first obstacle information based on the first depth image, wherein the first obstacle information is configured to characterize a shape, a size, and a distance to the mobile structure of each obstacle in a framing area corresponding to the first depth image; and
determining the target obstacle based on the first obstacle information.

13. The computing device according to claim 12, wherein the determining the first obstacle information based on the first depth image includes:
determining a first point cloud data set based on the first depth image; and
calculating the shape, the size and the distance to the mobile device of each obstacle in the framing area corresponding to the first depth image to obtain the first obstacle information based on the first depth image and the first point cloud data set; and
the determining the target obstacle based on the first obstacle information includes:
determining an obstacle with the shortest distance to the mobile structure in the current movement area as the target obstacle based on the first obstacle information.

14. The computing device according to claim 11, wherein, in a case that the obstacle prompting information is configured to prompt the outline shape of the target obstacle, the determining the target obstacle in the current movement area based on the detection image includes:
determining a second depth image corresponding to a first preset area of the detection image based on the detection image, wherein the first preset area corresponds to the current movement area;
determining second obstacle information based on the second depth image, wherein the second obstacle information is configured to characterize a shape, a size, and a distance to the mobile device of each obstacle in a framing area corresponding to the second depth image; and
determining the target obstacle based on the second obstacle information.

15. The computing device according to claim 14, wherein the determining the second obstacle information based on the second depth image includes:
determine a second point cloud data set based on the second depth image; and
based on the second depth image and the second point cloud data set, calculating the shape, the size and the distance to the mobile device of each obstacle in the framing area corresponding to the second depth image to obtain the second obstacle information; and
the determining the target obstacle based on the second obstacle information includes:
determining an obstacle with the shortest distance to the mobile structure in the current movement area as the target obstacle based on the second obstacle information.

16. The computing device according to claim 12, wherein the displaying the obstacle prompting information in the prompting area includes:
based on the shape and the size of the target obstacle and the distance to the mobile structure of the target obstacle, determining the outline shape of the target obstacle in the real-time image; and
displaying the obstacle prompting information in the prompting area based on the outline shape of the target obstacle in the real-time image.

17. The computing device according to claim 11, wherein, in a case that the obstacle prompting information is configured to prompt the outline shape of the prompting area, the determining the target obstacle in the current movement area based on the detection image includes:
determining a third depth image corresponding to the detection image based on the detection image;
calculating a distance between each obstacle in the framing area corresponding to the third depth image and the mobile structure based on the third depth image; and
determining an obstacle with the shortest distance to the mobile structure in the current movement area as the target obstacle.

18. The computing device according to claim 11, wherein, in a case that the obstacle prompting information is configured to prompt the outline shape of the prompting area, the determining the target obstacle in the current movement area based on the detection image includes:
based on the detection image, determining a fourth depth image corresponding to a second preset area of the detection image, and the second preset area corresponding to the current movement area;
calculating a distance between each obstacle in the framing area corresponding to the fourth depth image and the mobile structure based on the fourth depth image; and
determining an obstacle with the shortest distance to the mobile structure in the current movement area as the target obstacle.

19. The computing device according to claim 11, wherein the detection image is captured by a binocular camera of the mobile structure.

20. The mobile structure, wherein the mobile structure comprises the computing device according to claim 1.

21. The display, wherein the display comprises the computing device according to claim 1.
